(19) United States
(12) Patent Application Publication
(10) Pub. No.: US 2008/0208476 A1
(43) Pub. Date: Aug. 28, 2008

(54) SYSTEM AND METHOD FOR WATERFLOOD PERFORMANCE MONITORING

(76) Inventor: Hossein Karami, East Ahmadi (KW)

Correspondence Address: DUKE W. YEE;YEE & ASSOCIATES, P.C., P.O. BOX 802333, DALLAS, TX, 75380, US

(21) Appl. No.: 12/038,321

(22) Filed: Feb. 27, 2008

Related U.S. Application Data
(60) Provisional application No. 60/891,857, filed on Feb. 27, 2007.

(51) Int. Cl. G01V 1/40; E21B 47/00

(52) U.S. Cl. 702/6; 166/250.01

(57) ABSTRACT

Method, system and computer program product for controlling a production/injection operation for an oilfield, the oilfield having a first wellsite with a producing well advanced into subterranean formations with geological structures and reservoirs therein. Data from a plurality of data sources is collected with respect to a production/injection operation, wherein the collected data includes oil production data and fluid injection data. The collected data is stored in a database. Extracted data relating to a selected performance parameter to be monitored is extracted from the database, the extracted data is processed, and a graphical representation of the processed data is dynamically displayed to enable monitoring of the selected performance parameter.

### BACKGROUND OF THE INVENTION

This application claims priority based on U.S. Provisional Patent Application Ser. No. 60/891,857, filed on Feb. 27, 2007.

### FIELD OF THE INVENTION

The present invention relates to techniques for performing oilfield operations relating to subterranean formations having reservoirs therein. More particularly, the invention relates to techniques for performing oilfield operations involving monitoring of waterflood performance.

### BACKGROUND OF THE INVENTION

Oilfield operations, such as surveying, drilling, wireline testing, completions, production, planning and oilfield analysis, are typically performed to locate and gather valuable downhole fluids, including gases. Various aspects of the oilfield and its related operations are shown in FIGS. 1A-1D. As shown in FIG. 1A, surveys are often performed using acquisition methodologies, such as seismic scanners or surveyors to generate maps of underground formations. These formations are often analyzed to determine the presence of subterranean assets, such as valuable fluids or minerals. This information is used to assess the underground formations and locate the formations containing the desired subterranean assets. This information may also be used to determine whether the formations have characteristics suitable for storing hydrocarbons. Data collected from the acquisition methodologies may be evaluated and analyzed to determine whether such valuable assets are present and if they are reasonably accessible.

As shown in FIGS. 1B-1D, one or more wellsites may be positioned along the underground formations to gather valuable hydrocarbons from the subterranean reservoirs. The wellsites are provided with tools capable of locating and removing hydrocarbons, such as oil or gas, from the subterranean reservoirs. As shown in FIG. 1B, drilling tools are typically deployed from the oil and gas rigs and advanced into the earth along a path to locate reservoirs containing the valuable downhole assets. Fluid, such as drilling mud or other drilling fluids, is pumped down the wellbore through the drilling tool and out the drilling bit. The drilling fluid flows through the annulus between the drilling tool and the wellbore and out the surface, carrying away earth loosened during drilling. The drilling fluids return the earth to the surface, and exert pressure on the wellbore to prevent fluid in the surrounding earth from entering the wellbore and causing a ‘blow out.’

During the drilling operation, the drilling tool may perform downhole measurements to investigate downhole conditions. The drilling tool may be used to take core samples of the subsurface formations. In some cases, as shown in FIG. 1C, the drilling tool is removed and a wireline tool is deployed into the wellbore to perform additional downhole testing, such as logging or sampling. Steel casing may be run into the well to a desired depth and cemented into place along the wellbore wall. Drilling may be continued until the desired total depth is reached.

After the drilling operation is complete, the well may then be prepared for production. As shown in FIG. 1D, wellbore completions equipment is deployed into the wellbore to complete the well in preparation for the production of hydrocarbons therethrough. Hydrocarbons are then allowed to flow from downhole reservoirs, into the wellbore and to the surface. Production facilities are positioned at surface locations to collect the hydrocarbons from the wellsite(s). Hydrocarbons drawn from the subterranean reservoir(s) pass to the production facilities via transport mechanisms, such as tubing. Various equipment may be positioned about the oilfield to monitor oilfield parameters, to manipulate the oilfield operations and/or to separate and direct fluids from the wells. Surface equipment and completion equipment may also be used to inject fluids into reservoirs, either for storage or at strategic points to enhance production of the reservoir.

During the oilfield operations, data is typically collected for analysis and/or monitoring of the oilfield operations. Such data may include, for example, subterranean formation, equipment, historical, and/or other data. Data concerning the subterranean formation is collected using a variety of sources. Such formation data may be static or dynamic. Static data relates to, for example, formation structure and geological stratigraphy that define geological structures of the subterranean formation. Dynamic data relates to, for example, fluids flowing through the geologic structures of the subterranean formation over time. Such static and/or dynamic data may be collected to learn more about the formations and the valuable assets contained therein.

Sources used to collect static data may be seismic tools, such as a seismic truck that sends compression waves into the earth as shown in FIG. 1A. Signals from these waves are processed and interpreted to characterize changes in the anisotropic and/or elastic properties, such as velocity and density, of the geological formation at various depths. This information may be used to generate basic structural maps of the subterranean formation. Other static measurements may be gathered using downhole measurements, such as core sampling and well logging techniques. Core samples are used to take physical specimens of the formation at various depths as shown in FIG. 1B. Well logging involves deployment of a downhole tool into the wellbore to collect various downhole measurements, such as density, resistivity, etc., at various depths. Such well logging may be performed using, for example, the drilling tool of FIG. 1B and/or the wireline tool of FIG. 1C. Once the well is formed and completed, fluid flows to the surface using production tubing and other completion equipment as shown in FIG. 1D. As fluid passes to the surface, various dynamic measurements, such as fluid flow rates, pressure and composition may be monitored. These parameters may be used to determine various characteristics of the subterranean formation.

Sensors may be positioned about the oilfield to collect data relating to various oilfield operations. For example, sensors in the drilling equipment may monitor drilling conditions, sensors in the wellbore may monitor fluid composition, sensors located along the flow path may monitor flow rates, and sensors at the processing facility may monitor fluids collected. Other sensors may be provided to monitor downhole, surface, equipment, or other conditions. Such conditions may relate to the type of equipment at the wellsite, the operating setup, formation parameters, or other variables of the oilfield. The monitored data is often used to make decisions at various locations of the oilfield at various times. Data collected by these sensors may be further analyzed and processed. Data may be collected and used for current or future operations. When used for future operations at the same or other locations, such data may sometimes be referred to as historical data.

The data may be used to predict downhole conditions and make decisions concerning oilfield operations. Such decisions may involve well planning, well targeting, well completions, operating levels, production rates, and other operations and/or operating parameters. Often this information is used to determine when (and/or where) to drill new wells, re-complete existing wells, or alter wellbore production. Oilfield conditions, such as geological, geophysical, and reservoir engineering characteristics may have an impact on oilfield operations, such as risk analysis, economic valuation, and mechanical considerations for the production of subsurface reservoirs.

Data from one or more wellbores may be analyzed to plan or predict various outcomes at a given wellbore. In some cases, the data from neighboring wellbores or wellbores with similar conditions or equipment may be used to predict how a well will perform. There are usually a large number of variables and large quantities of data to consider in analyzing oilfield operations. It is, therefore, often useful to model the behavior of the oilfield operation to determine a desired course of action. During the ongoing operations, the operating parameters may need adjustment as oilfield conditions change and new information is received.

Techniques have been developed to model the behavior of geological formations, downhole reservoirs, wellbores, and surface facilities, as well as other portions of the oilfield operation. Examples of these modeling techniques are shown in Patent/Application Nos. U.S. Pat. No. 5,992,519, WO2004049216, WO1999/064896, U.S. Pat. No. 6,313,837, US2003/0216897, U.S. Pat. No. 7,248,259, US20050149307, and US2006/0197759. Typically, existing modeling techniques have been used to analyze only specific portions of the oilfield operations. More recently, attempts have been made to use more than one model in analyzing certain oilfield operations. See, for example, US Patent/Application Nos. U.S. Pat. No. 6,980,940, WO04049216, 20040220846 and Ser. No. 10/586,283. Additionally, techniques for modeling certain aspects of an oilfield have been developed, such as OPENWORKS™ with, e.g., SEISWORKS™, STRATWORKS™, GEOPROBE™ or ARIES™ by LANDMARK™ (see www.lgc.com); VOXELGEO™, GEOLOG™ and STRATIMAGIC™0 by PARADIGM™ (see www.paradigmgeo.com); JEWELSUITE™ by JOA™ (see www.jewelsuite.com); RMS™ products by ROXAR™ (see www.roxar.com); and PETREL™ by SCHLUMBERGER™.

Software applications have been developed to process drilling data and facilitate the completion of the above-referenced drilling techniques. Examples of software applications for processing drilling data include PERFORM™ Toolkit, Osprey™ Risk, DrillDB™, and DIMS®. PERFORM Toolkit, Osprey Risk, and DrillDB are software packages available from Schlumberger Technology Corporation. DIMS is a software package offered by Halliburton Company. In addition, software applications have been developed for reporting oilfield data. For example, Osprey Reports and OpenWells® are software applications for providing reporting systems for drilling operations. Osprey Reports is a software package available from Schlumberger Technology Corporation. OpenWells is a software application available from Halliburton Company.

Despite the development and advancement of various aspects of oilfield data analysis, there remains a need to provide techniques for enhancing the recovery of hydrocarbons from underground formations. Waterflood is an effective mechanism for enhancing the recovery of hydrocarbons, such as oil from underground formations. Waterflood is a method for secondary recovery of hydrocarbons such as oil in which water is injected into a reservoir formation to displace residual oil. The water from injection wells physically sweeps the displaced oil to adjacent production wells where the oil may be extracted.

Monitoring the ratio of injected water against produced oil is crucial to the successful outcome of waterflood projects. Current waterflood monitoring workflows require the use of a database, such as a Finder®, in conjunction with several applications, in order to perform a reservoir monitoring process. (The Finder software program is available from Schlumberger.) Furthermore, these applications are typically maintained by different individuals, and in order to properly complete a waterflood monitoring process, it is necessary for all of these individuals to be available. At the same time, however, these individuals are also required to devote a substantial amount of time to downloading data, loading data, manually processing data within the various applications, and the like. As a result, the overall waterflood monitoring process is difficult to maintain and is subject to human error.

There is, accordingly, a need for a mechanism for enhancing the waterflood monitoring process. It is desirable that such mechanism enhance the reservoir monitoring process by integrating a Finder database with only a single data processing application. It is further desirable that such single application incorporate a robust visualization tool to provide rapid graphical presentations that facilitate waterflood monitoring.

### SUMMARY OF THE INVENTION

In at least one aspect, the invention relates to a method for controlling a production/injection operation for an oilfield, the oilfield having a first wellsite with a producing well advanced into subterranean formations with geological structures and reservoirs therein. Data from a plurality of data sources is collected with respect to a production/injection operation, wherein the collected data includes oil production data and fluid injection data. The collected data is stored in a database. Extracted data relating to a selected performance parameter to be monitored is extracted from the database, the extracted data is processed, and a graphical representation of the processed data is dynamically displayed to enable monitoring of the selected performance parameter.

In another aspect, the invention relates to a system for controlling a production/injection operation for an oilfield, the oilfield having a first wellsite with a producing well advanced into subterranean formations with geological structures and reservoirs therein, for the purpose of production of fluids from the reservoirs or injection of fluid such as water into the reservoirs to enhance production. The system has a plurality of data collecting mechanisms for collecting collected data with respect to the production/injection operation, wherein the collected data includes oil production data and fluid injection data, and a database for storing the collected data. A data extraction and processing mechanism extracts data from the database relating to a selected performance parameter to be monitored, and processes the extracted data. A data visualizing mechanism dynamically displays a graphical representation of the processed data to enable monitoring of the selected performance parameter.

In yet another aspect, the invention relates to a computer program product comprising a computer usable medium having computer usable program code for controlling a production/injection operation for an oilfield, the oilfield having a first wellsite with a producing well advanced into subterranean formations with geological structures and reservoirs therein. The computer program product has computer usable program code for collecting data from a plurality of data sources with respect to the production/injection operation, wherein the collected data includes oil production data and fluid injection data, and computer usable program code for storing the collected data in a database. The computer program product also has computer usable program code for extracting data from the database relating to a selected performance parameter to be monitored, computer usable program code for processing the extracted data, and computer usable program code for dynamically displaying a graphical representation of the processed data to enable monitoring of the selected performance parameter.

Other aspects of the invention may be determined from the description herein.

### BRIEF DESCRIPTION OF THE DRAWINGS

So that the above described features and advantages of the present invention can be understood in detail, a more particular description of the invention, briefly summarized above, may be had by reference to the embodiments thereof that are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-1D depict a simplified, schematic view of an oilfield having subterranean formations containing reservoirs therein, the various oilfield operations being performed on the oilfield. FIG. 1A depicts a survey operation being performed by a seismic truck. FIG. 1B depicts a drilling operation being performed by a drilling tool suspended by a rig and advanced into the subterranean formations. FIG. 1C depicts a wireline operation being performed by a wireline tool suspended by the rig and into the wellbore of FIG. 1B. FIG. 1D depicts a production operation being performed by a production tool being deployed from a production unit and into the completed wellbore of FIG. 1C for drawing fluid from the reservoirs into surface facilities.

FIGS. 2A-2D are graphical depictions of data collected by the tools of FIGS. 1A-1D, respectively. FIG. 2A depicts a seismic trace of the subterranean formation of FIG. 1A. FIG. 2B depicts a core test result of the core sample of FIG. 1B. FIG. 2C depicts a well log of the subterranean formation of FIG. 1C. FIG. 2D depicts a production decline curve of fluid flowing through the subterranean formation of FIG. 1D.

FIG. 3 is a schematic view, partially in cross-section, of an oilfield having a plurality of data acquisition tools positioned at various locations along the oilfield for collecting data from the subterranean formations.

FIG. 4A is an illustration depicting a production field having both injection wells and producing wells.

FIG. 4B is an illustration depicting a simplified cross section of an oil field having an injection well and a producing well.

FIG. 5 is an illustration depicting a known workflow for monitoring waterflood performance.

FIG. 6 is an illustration of a block diagram of a system for monitoring waterflood performance.

FIG. 7 is an illustration depicting a workflow for generating pattern base maps.

FIG. 8 is an illustration depicting a workflow for generating pattern VRR maps.

FIG. 9 is an illustration depicting a workflow for generating injector/producer water cut maps.

FIG. 10 is a flowchart of a method for monitoring waterflood performance.

### DETAILED DESCRIPTION OF THE INVENTION

Presently preferred embodiments of the invention are shown in the above-identified figures and described in detail below. In describing the preferred embodiments, like or identical reference numerals are used to identify common or similar elements. The figures are not necessarily to scale and certain features and certain views of the figures may be shown exaggerated in scale or in schematic in the interest of clarity and conciseness.

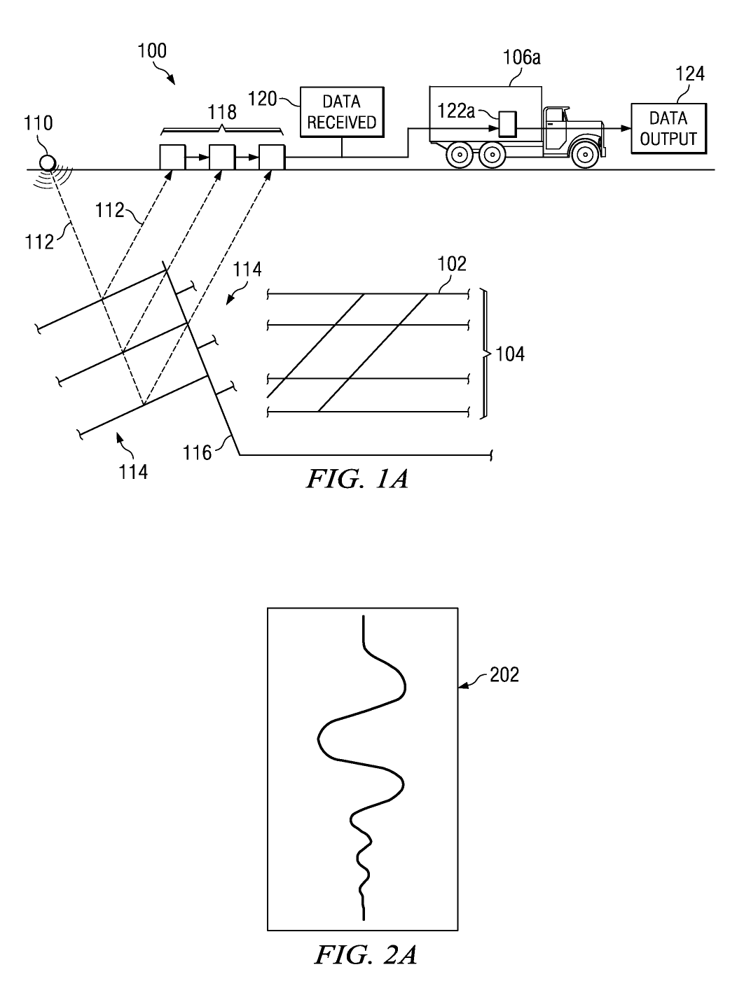

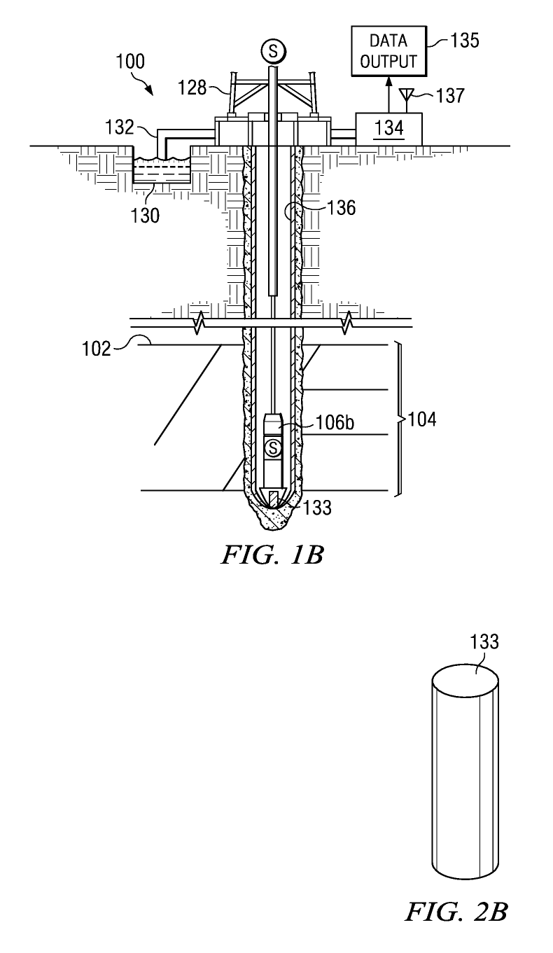

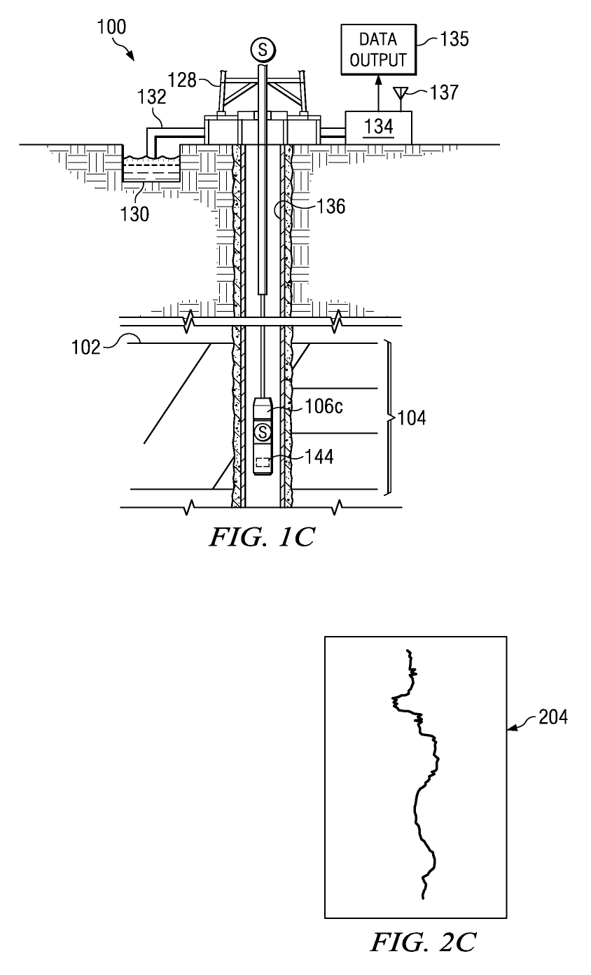

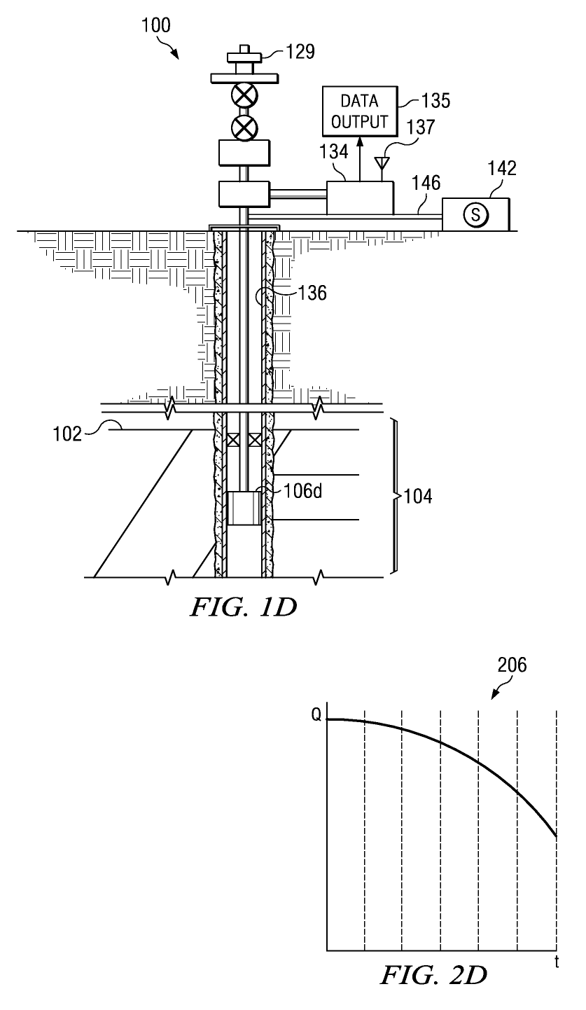

FIGS. 1A-1D depict simplified, representative, schematic views of oilfield 100 having subterranean formation 102 containing reservoir 104 therein and depicting various oilfield operations being performed on the oilfield. FIG. 1A depicts a survey operation being performed by a survey tool, such as seismic truck 106a, to measure properties of the subterranean formation. The survey operation is a seismic survey operation for producing sound vibrations. In FIG. 1A, one such sound vibration, sound vibration 112 generated by source 110, reflects off horizons 114 in earth formation 116. A set of sound vibrations, such as sound vibration 112 is received by sensors, such as geophone-receivers 118, situated on the earth's surface. In response to receiving these vibrations, geophone receivers 118 produce electrical output signals, referred to as data received 120 in FIG. 1A.

In response to the received sound vibration(s) 112 representative of different parameters (such as amplitude and/or frequency) of sound vibration(s) 112, geophones 118 produce electrical output signals containing data concerning the subterranean formation. Data received 120 is provided as input data to computer 122a of seismic truck 106a, and responsive to the input data, computer 122a generates seismic data output 124. This seismic data output may be stored, transmitted or further processed as desired, for example, by data reduction.

FIG. 1B depicts a drilling operation being performed by drilling tools 106b suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is usually filtered and returned to the mud pit. A circulating system may be used for storing, controlling, or filtering the flowing drilling muds. The drilling tools are advanced into the subterranean formations 102 to reach reservoir 104. Each well may target one or more reservoirs. The drilling tools are preferably adapted for measuring downhole properties using logging while drilling tools. The logging while drilling tools may also be adapted for taking core sample 133 as shown, or removed so that a core sample may be taken using another tool

Surface unit 134 is used to communicate with the drilling tools and/or offsite operations, as well as with other surface or downhole sensors. Surface unit 134 is capable of communicating with the drilling tools to send commands to the drilling tools, and to receive data therefrom. Surface unit 134 is preferably provided with computer facilities for receiving, storing, processing, and/or analyzing data from the oilfield. Surface unit 134 collects data generated during the drilling operation and produces data output 135 which may be stored or transmitted. Computer facilities, such as those of the surface unit, may be positioned at various locations about the oilfield and/or at remote locations.

Sensors S, such as gauges, may be positioned about the oilfield to collect data relating to various oilfield operations as described previously. As shown, sensor S is positioned in one or more locations in the drilling tools and/or at rig 128 to measure drilling parameters, such as weight on bit, torque on bit, pressures, temperatures, flow rates, compositions, rotary speed, and/or other parameters of the oilfield operation. Sensors S may also be positioned in one or more locations in the circulating system.

The data gathered by sensors S may be collected by surface unit 134 and/or other data collection sources for analysis or other processing. The data collected by sensors S may be used alone or in combination with other data. The data may be collected in one or more databases and/or transmitted on or offsite. All or select portions of the data may be selectively used for analyzing and/or predicting oilfield operations of the current and/or other wellbores. The data may be historical data, real time data, or combinations thereof. The real time data may be used in real time, or stored for later use. The data may also be combined with historical data or other inputs for further analysis. The data may be stored in separate databases, or combined into a single database.

The collected data may be used to perform analysis, such as modeling operations. For example, the seismic data output may be used to perform geological, geophysical, and/or reservoir engineering. The reservoir, wellbore, surface, and/or process data may be used to perform reservoir, wellbore, geological, geophysical, or other simulations. The data outputs from the oilfield operation may be generated directly from the sensors, or after some preprocessing or modeling. These data outputs may act as inputs for further analysis.

The data may be collected and stored at surface unit 134. One or more surface units may be located at oilfield 100, or connected remotely thereto. Surface unit 134 may be a single unit, or a complex network of units used to perform the necessary data management functions throughout the oilfield. Surface unit 134 may be a manual or automatic system. Surface unit 134 may be operated and/or adjusted by a user.

Surface unit 134 may be provided with transceiver 137 to allow communications between surface unit 134 and various portions of oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via the transceiver or may itself execute commands to the controller. A processor may be provided to analyze the data (locally or remotely), make the decisions and/or actuate the controller. In this manner, oilfield 100 may be selectively adjusted based on the data collected. This technique may be used to optimize portions of the oilfield operation, such as controlling drilling, weight on bit, pump rates, or other parameters. These adjustments may be made automatically based on computer protocol, and/or manually by an operator. In some cases, well plans may be adjusted to select optimum operating conditions, or to avoid problems.

FIG. 1C depicts a wireline operation being performed by wireline tool 106c suspended by rig 128 and into wellbore 136 of FIG. 1B. Wireline tool 106c is preferably adapted for deployment into a wellbore for generating well logs, performing downhole tests and/or collecting samples. Wireline tool 106c may be used to provide another method and apparatus for performing a seismic survey operation. Wireline tool 106c of FIG. 1C may, for example, have an explosive, radioactive, electrical, or acoustic energy source 144 that sends and/or receives electrical signals to surrounding subterranean formations 102 and fluids therein.

Wireline tool 106c may be operatively connected to, for example, geophones 118 and computer 122a of seismic truck 106a of FIG. 1A. Wireline tool 106c may also provide data to surface unit 134. Surface unit 134 collects data generated during the wireline operation and produces data output 135 that may be stored or transmitted. Wireline tool 106c may be positioned at various depths in the wellbore to provide a survey or other information relating to the subterranean formation.

Sensors S, such as gauges, may be positioned about oilfield 100 to collect data relating to various oilfield operations as described previously. As shown, the sensor S is positioned in wireline tool 106c to measure downhole parameters which relate to, for example porosity, permeability, fluid composition and/or other parameters of the oilfield operation.

FIG. 1D depicts a production operation being performed by production tool 106d deployed from a production unit or Christmas tree 129 and into completed wellbore 136 for drawing fluid from the downhole reservoirs into surface facilities 142. Fluid flows from reservoir 104 through perforations in the casing (not shown) and into production tool 106d in wellbore 136 and to surface facilities 142 via a gathering network 146.

Sensors S, such as gauges, may be positioned about oilfield 100 to collect data relating to various oilfield operations as described previously. As shown, the sensor S may be positioned in production tool 106d or associated equipment, such as Christmas tree 129, gathering network 146, surface facility 142, and/or the production facility, to measure fluid parameters, such as fluid composition, flow rates, pressures, temperatures, and/or other parameters of the production operation.

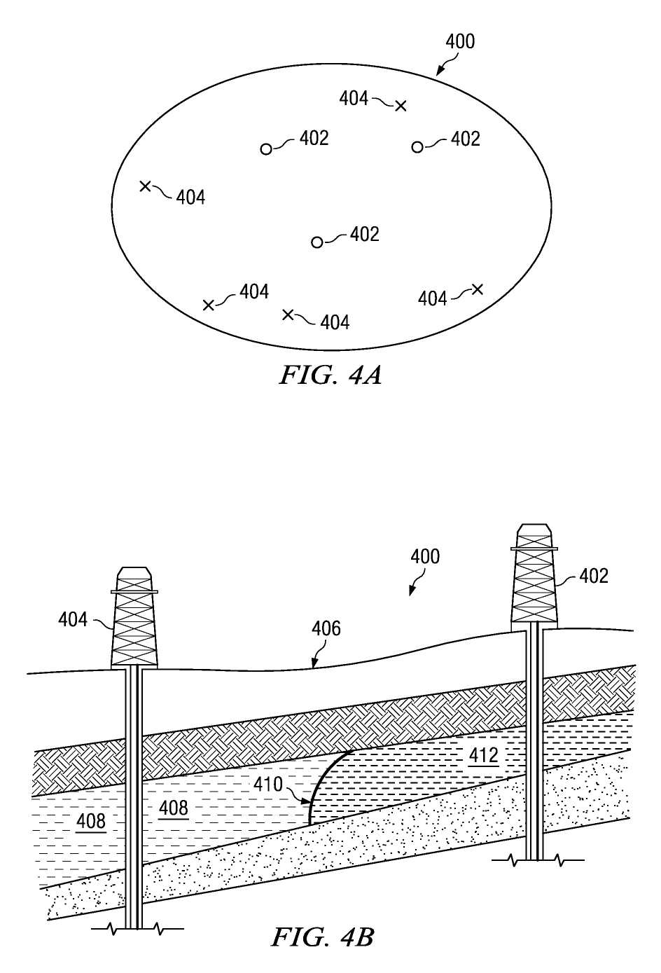

While only simplified wellsite configurations are shown, it will be appreciated that the oilfield may cover a portion of land, sea, and/or water locations that hosts one or more wellsites. Production may also include injection wells (See FIG. 4A and FIG. 4B) for added recovery. One or more gathering facilities may be operatively connected to one or more of the wellsites for selectively collecting downhole fluids from the wellsite(s).

While FIGS. 1B-1D depict tools used to measure properties of an oilfield, it will be appreciated that the tools may be used in connection with non-oilfield operations, such as gas fields, mines, aquifers, storage, or other subterranean facilities that could benefit from waterflooding. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors S may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with the present invention. Part, or all, of field 100 may be on land, water, and/or sea. Also, while a single field measured at a single location is depicted, the present invention may be utilized with any combination of one or more fields, one or more processing facilities and one or more wellsites.

FIGS. 2A-2D are graphical depictions of examples of data collected by the tools of FIGS. 1A-1D, respectively. FIG. 2A depicts seismic trace 202 of the subterranean formation of FIG. 1A taken by seismic truck 106a. Seismic trace 202 may be used to provide data, such as a two-way response over a period of time. FIG. 2B depicts core sample 133 taken by drilling tools 106b. Core sample 133 may be used to provide data, such as a graph of the density, porosity, permeability, or other physical property of the core sample over the length of the core. Tests for density and viscosity may be performed on the fluids in the core at varying pressures and temperatures. FIG. 2C depicts well log 204 of the subterranean formation of FIG. 1C taken by wireline tool 106c. The wireline log typically provides a resistivity or other measurement of the formation at various depths. FIG. 2D depicts a production decline curve or graph 206 of fluid flowing through the subterranean formation of FIG. 1D measured at surface facilities 142. The production decline curve typically provides the production rate Q as a function of time t.

The respective graphs of FIGS. 2A-2C depict examples of static measurements that may describe or provide information about the physical characteristics of the formation and reservoirs contained therein. These measurements may be analyzed to better define the properties of the formation(s) and/or determine the accuracy of the measurements and/or for checking for errors. The plots of each of the respective measurements may be aligned and scaled for comparison and verification of the properties.

FIG. 2D depicts an example of a dynamic measurement of the fluid properties through the wellbore. As the fluid flows through the wellbore, measurements are taken of fluid properties, such as flow rates, pressures, composition, etc. As described below, the static and dynamic measurements may be analyzed and used to generate models of the subterranean formation to determine characteristics thereof. Similar measurements may also be used to measure changes in formation aspects over time.

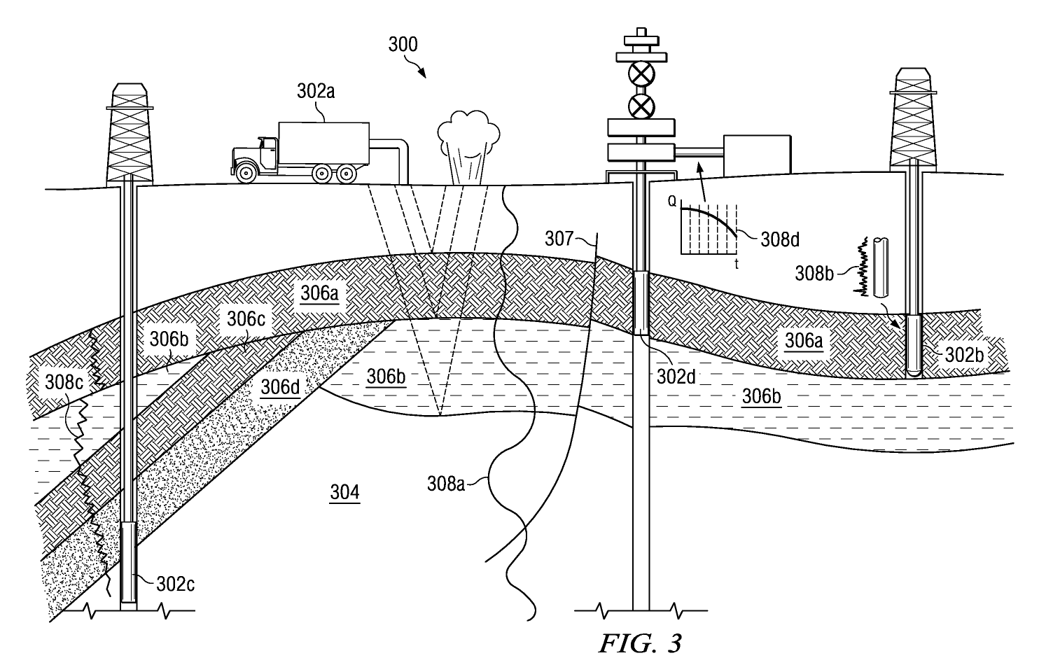

FIG. 3 is a schematic view, partially in cross section of oilfield 300 having data acquisition tools 302a, 302b, 302c and 302d positioned at various locations along the oilfield for collecting data of the subterranean formation 304. Data acquisition tools 302a-302d may be the same as data acquisition tools 106a-106d of FIGS. 1A-1D, respectively, or others not depicted. As shown, data acquisition tools 302a-302d generate data plots or measurements 308a-308d, respectively. These data plots are depicted along the oilfield to demonstrate the data generated by the various operations.

Data plots 308a-308c are examples of static data plots that may be generated by data acquisition tools 302a-302d, respectively, however, it should be understood that data plots 308a-308c may also be data plots that are updated in real time. Static data plot 308a is a seismic two-way response time and may be the same as seismic trace 202 of FIG. 2A. Static plot 308b is core sample data measured from a core sample of formation 304, similar to core sample 133 of FIG. 2B. Static data plot 308c is a logging trace, similar to well log 204 of FIG. 2C. Production decline curve or graph 308d is a dynamic data plot of the fluid flow rate over time, similar to graph 206 of FIG. 2D. Other data may also be collected, such as historical data, user inputs, economic information, and/or other measurement data and other parameters of interest.

Subterranean structure 304 has a plurality of geological formations 306a-306d. As shown, this structure has several formations or layers, including shale layer 306a, carbonate layer 306b, shale layer 306c and sand layer 306d. Fault 307 extends through shale layer 306a and carbonate layer 306b. The static data acquisition tools are preferably adapted to take measurements and detect characteristics of the formations.

While a specific subterranean formation with specific geological structures is depicted, it will be appreciated that the oilfield may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in the oilfield, it will be appreciated that one or more types of measurement may be taken at one or more locations across one or more oilfields or other locations for comparison and/or analysis.

The data collected from various sources, such as the data acquisition tools of FIG. 3, may then be processed and/or evaluated. Typically, seismic data displayed in static data plot 308a from data acquisition tool 302a is used by a geophysicist to determine characteristics of the subterranean formations and features. Core data shown in static plot 308b and/or log data from well log 308c are typically used by a geologist to determine various characteristics of the subterranean formation. Production data from graph 308d is typically used by the reservoir engineer to determine fluid flow reservoir characteristics. The data analyzed by the geologist, geophysicist and the reservoir engineer may be analyzed using modeling techniques. Examples of modeling techniques are described in U.S. Pat. No. 5,992,519, WO2004049216, WO1999/064896, U.S. Pat. No. 6,313,837, US2003/0216897, U.S. Pat. No. 7,248,259, US20050149307 and US2006/0197759. Systems for performing such modeling techniques are described, for example, in issued U.S. Pat. No. 7,248,259, the entire contents of which is hereby incorporated by reference.

FIG. 4A is an illustration depicting a production field having both injection wells and producing wells. Production field 400 is an oil production field having a number of production wells, such as production wells 402. Each production well 402 is a wellbore that has been drilled into the ground for the purpose of extracting oil from an underground reservoir. Production field 400 can also represent wellbores drilled to extract fluids other than oil.

In addition to production wells 402, production field 400 also includes a number of injection wells 404. An injection well is a wellbore into which a fluid, such as but not limited to water, carbon dioxide gas, or an oil/water miscible mixture, is injected under pressure. The purpose of injection wells 404 is to use the fluid pressure to force subterranean oil away from injection wells 404 and into production wells 402. Thus, injection wells 404 are used to increase the overall oil produced by production wells 402.

The function of any given wellbore can change during the lifetime of the wellbore. For example, production wells 402 can later be used as injection wells 404, and injection wells 404 might later become production wells 402, and back again.

The placement of injection wells 404 can be a very difficult challenge, as local geology, production wells 402, injection wells 404, and fluid injection parameters (such as fluid type and pressure) interact with each other to change how subterranean oil within production field 400 moves in response to the application of fluid pressure from injection wells 404 and in response to the drawing of oil from production wells 402. To predict the effects of application of a particular pressure of a particular fluid type, many measurements are made. As a result, a great deal of data is obtained and then managed.

FIG. 4B is an illustration depicting a simplified cross section of an oil field having an injection well and a producing well. In particular, FIG. 4B is a cross section of a smaller portion of production field 400 shown in FIG. 4A. Thus, similar reference numerals are used with respect to FIG. 4A and FIG. 4B. FIG. 4B illustrates the operation of an injection well.

Production field 400 includes production well 402 and injection well 404. Neither production well 402 nor injection well 404 are necessarily drawn to scale, though both penetrate surface 406, which is the surface of the Earth.

In this illustrative example, a fluid is injected via injection well 404 into the ground. As a result, high fluid pressure zone 408 is created. The fluid pressure is “high” relative to normal local subterranean pressure. In turn, high fluid pressure zone 408 pushes other fluids, such as oil, in the ground away from injection well 404. The resulting fluid/oil boundary 410 shows where oil is being pushed towards production well 402, as shown by oil movement zone 412. Because oil is moving towards production well 402 in oil movement zone 412, additional oil can be extracted via production well 402.

This process of increased oil production via fluid injection can be referred-to as “waterflood” when water, or a mixture of water and other fluids, is the injected fluid. Waterflood is an effective mechanism for enhancing the recovery of hydrocarbons such as oil from underground formations. Again, waterflood is a process of secondary recovery in which water is injected into a reservoir formation in order to displace residual oil and maintain the reservoir pressure. The water physically sweeps the displaced oil to adjacent production wells, such as production well 402.

Potential problems that may be associated with waterflood techniques include inefficient recovery due to variable permeability, or similar conditions affecting fluid transport within the reservoir, and early water breakthrough that may cause production and surface processing problems. As a result of such potential problems, and for other reasons, it is important to monitor the waterflood process in order to ensure that it is operating in an efficient, effective manner.

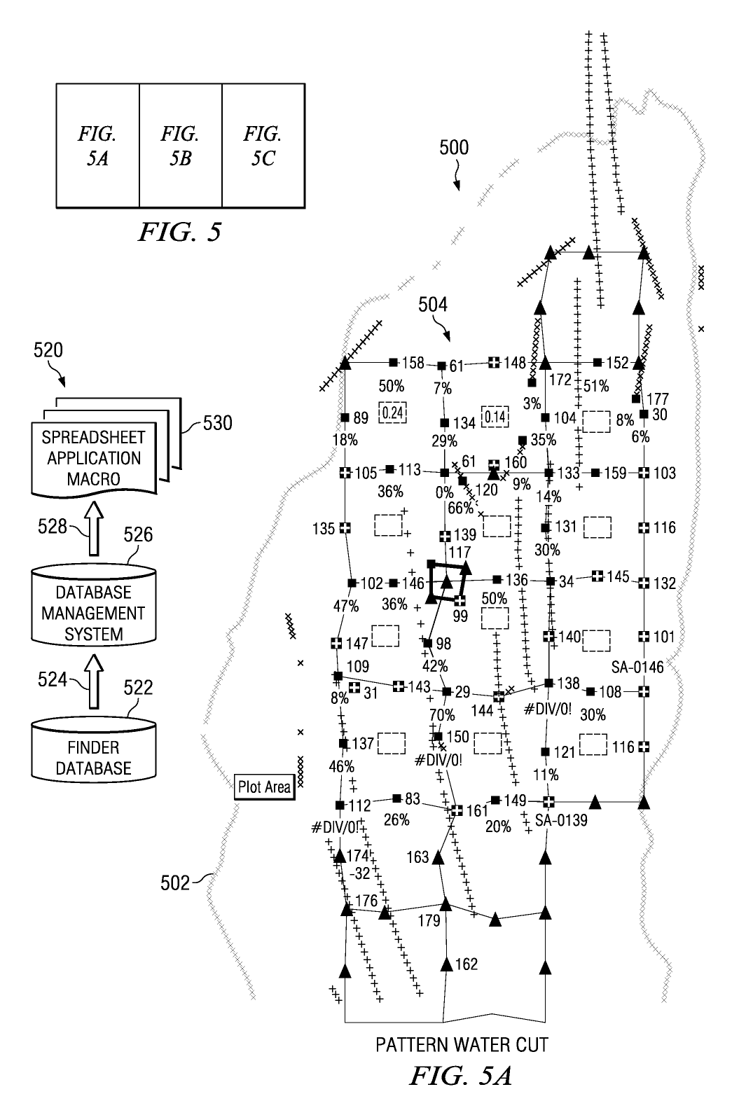

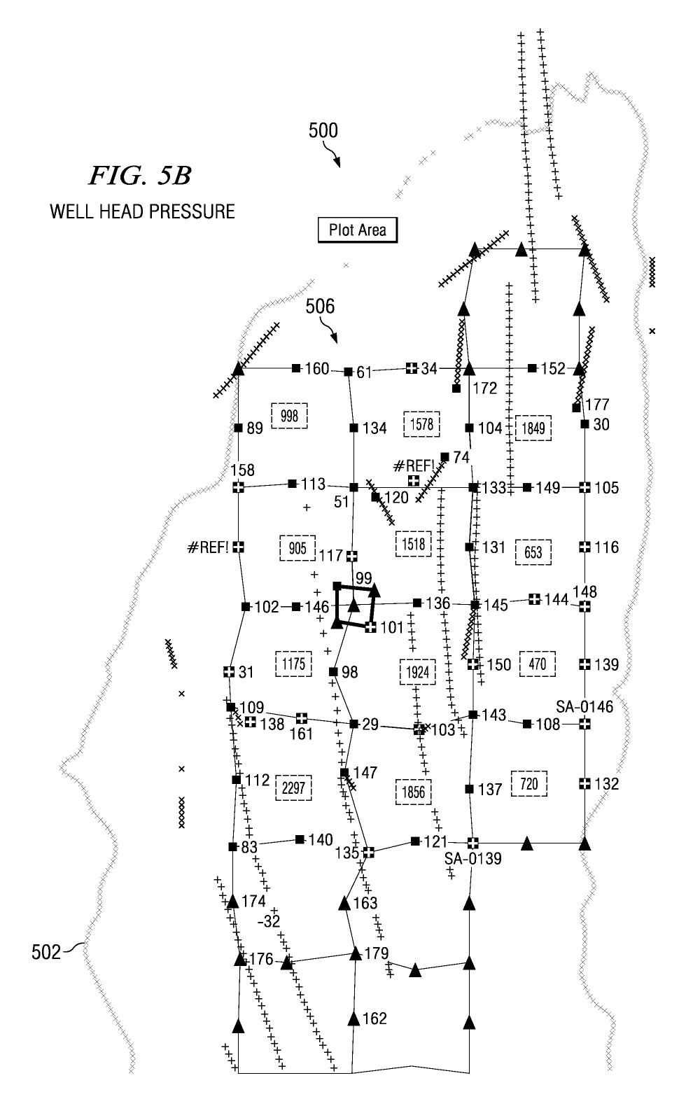

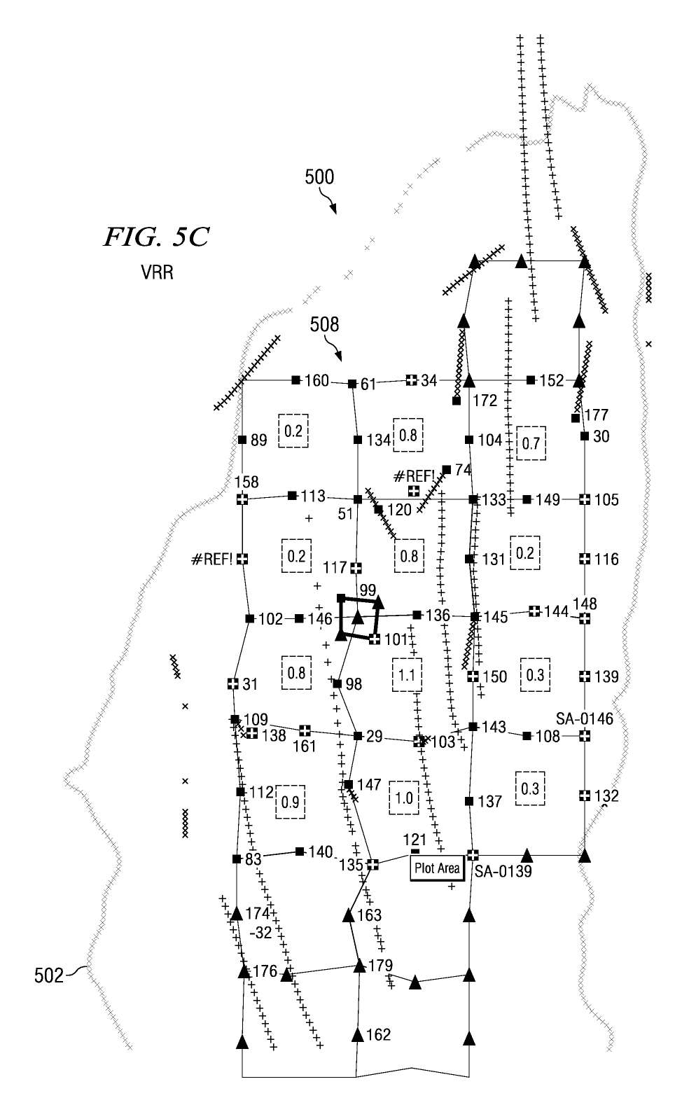

A field development team has two waterflood implementations: oil production and water injection. Data relating to these aspects are gathered and typically stored in a database (522 in FIG. 5), such as Schlumberger's Finder® database. The database is used as an information source to enable monitoring of waterflood performance.

FIG. 5 is an illustration depicting a known workflow for monitoring waterflood performance. The workflow is generally designated by reference number 500, and illustrates waterflood monitoring data for a single month over a plot area, generally designated by reference number 502. In FIG. 5, the monitored data includes pattern watercut data 504, injection well head pressure data 506, and voltage replacement ratio (VRR) data 508.

The manner by which waterflood performance data, such as data 504, 506 and 508, is obtained is schematically illustrated at 520. Initially, data that has been gathered at the well site, including injection data and production data, are stored in finder database 522, which is typically maintained by a corporate entity, and, accordingly, may also be referred to as a corporate database. Finder database 522 may, for example, comprise an Oracle™ database.

Individuals requiring access to data stored in finder database 522 previously retrieved the data via a link, schematically illustrated at 524, between finder database 522 and database management system 526, such as MS Office Access™ The retrieved data was then fed into spreadsheet application macro 530, such as a Microsoft Excel™ macro, via link 528 to enable further calculation and manual data manipulation and processing including mapping.

As is apparent, performance monitoring workflow 520 requires the use of several applications. Furthermore, each application is usually maintained by a different individual. As a result, in order to complete a waterflood monitoring process, it is necessary for all of these individuals to be available. At the same time, however, these individuals are also required to devote a substantial period of time downloading data, loading data, manually processing data within the various applications, and the like. The overall monitoring process is thus difficult to maintain and is also subject to human errors.

Yet further, because the different applications are maintained by different individuals, if one of the individuals were to resign or otherwise become unavailable, it becomes quite difficult for another individual to properly use the application being handled by the unavailable individual, often resulting in spreadsheet application macro 530 becoming corrupted.

The insufficiencies in the known workflows for monitoring waterflood performance, such as the workflow illustrated in FIG. 5 has been alleviated by providing an improved workflow that enhances the monitoring process by integrating a database, preferably a Finder database, with a single data processing application that incorporates a robust visualization tool that provides rapid graphical presentation, i.e., that reduces data gathering, processing, and analysis to minutes rather than days as is typical in known workflows.

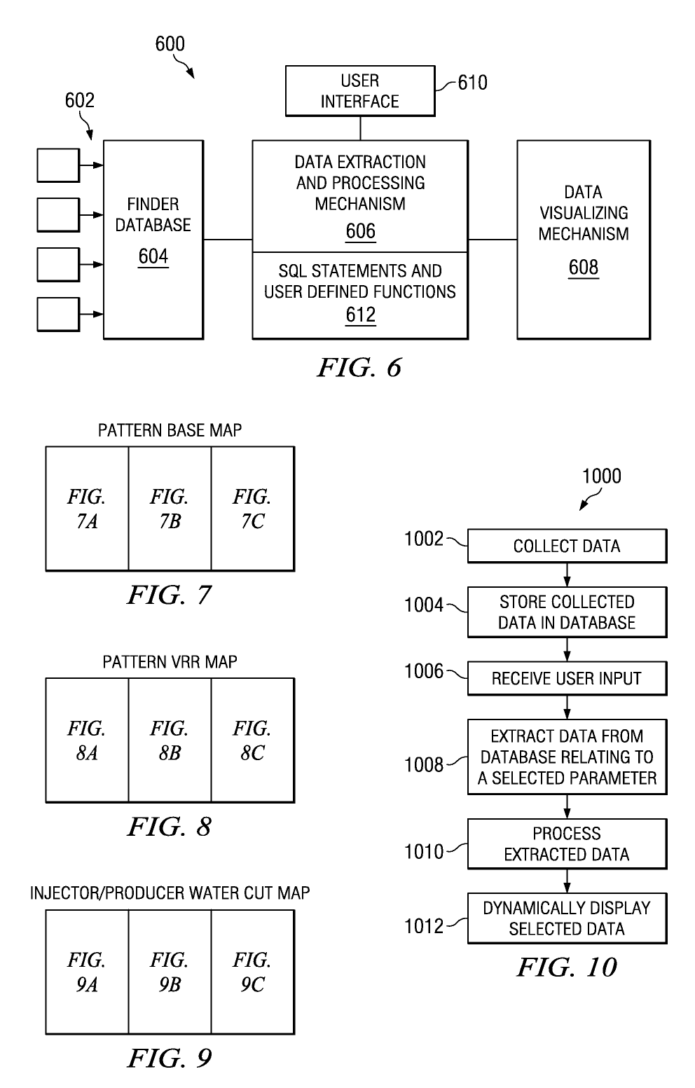

FIG. 6 is an illustration of a block diagram of a system for monitoring waterflood performance. The system is generally designated by reference number 600, and includes Finder database 604 that stores data that has been gathered at the well site, including injection data and production data. Such data has been gathered by a plurality of data collecting mechanisms, schematically illustrated 602, which may, for example, be implemented as sensors S illustrated in FIGS. 1A-1D and FIGS. 4A-4B. Such sensors may be positioned about an oilfield to collect data relating to oilfield operations and provide diverse data regarding waterflood production as will be described more fully hereinafter.

Waterflood performance monitoring system 600 also includes data extraction and processing mechanism 606. Data extraction and processing mechanism 606 extracts data from Finder database 604 relating to a selected waterflood performance parameter to be monitored and processes the extracted data. Data extraction and processing mechanism 606 comprises a single application, referred to herein as a Finder® SmartMap application, which extracts selected production/injection data from Finder database 604 and processes the data using embedded SQL (structured query language) statements and user defined functions 612.

The result of the processed data is then displayed by data visualizing mechanism 608. More particularly, data visualizing mechanism 608 comprises a GIS (geographic information system)—based map, referred to herein as a “SmartMap”, onto which the processed data is projected. Data visualizing mechanism 608 is interactive, and waterflood performance monitoring system 600 also includes user interface 610 for receiving user input. For example, using user interface 610, a user is able to input a specific waterflood performance parameter of interest and a period of time, such as a month or a week for which he or she wants data with respect to the parameter to be extracted, processed, and displayed.

Waterflood performance monitoring system 600 enables a user to see the results of the processing in only a few seconds without going through a rigorous process of loading/unloading, calculating, and visualizing the data by using different applications as in known systems.

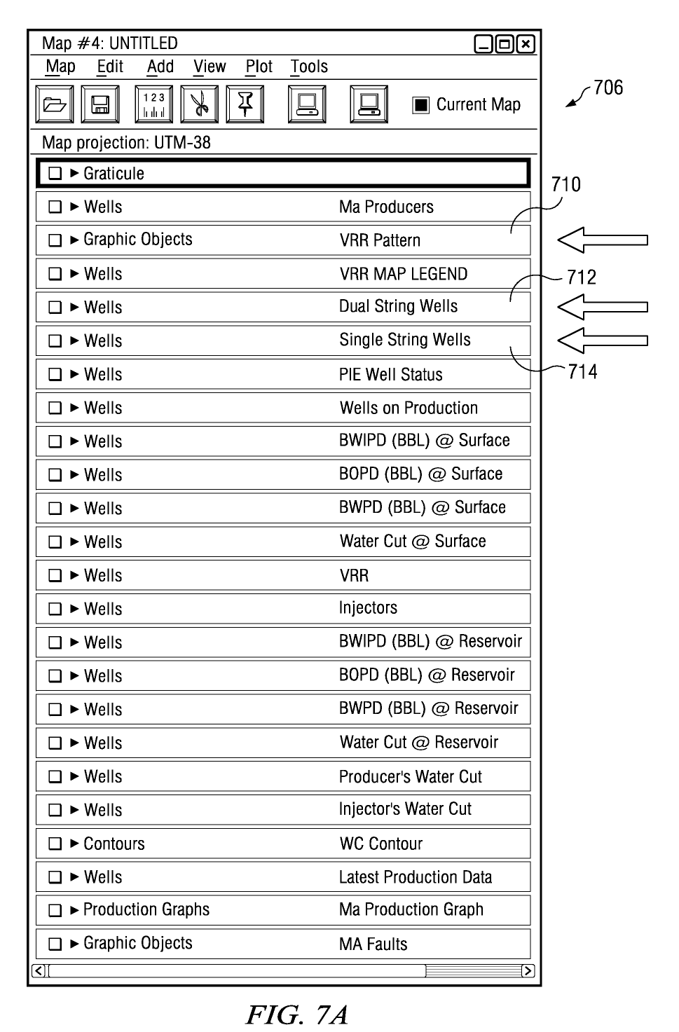

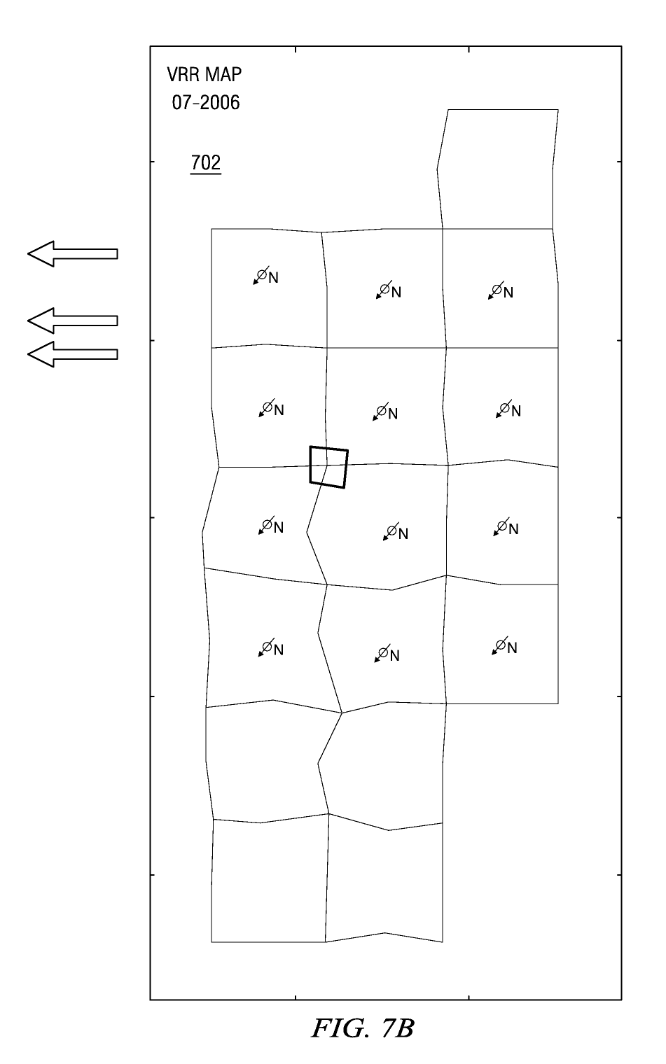

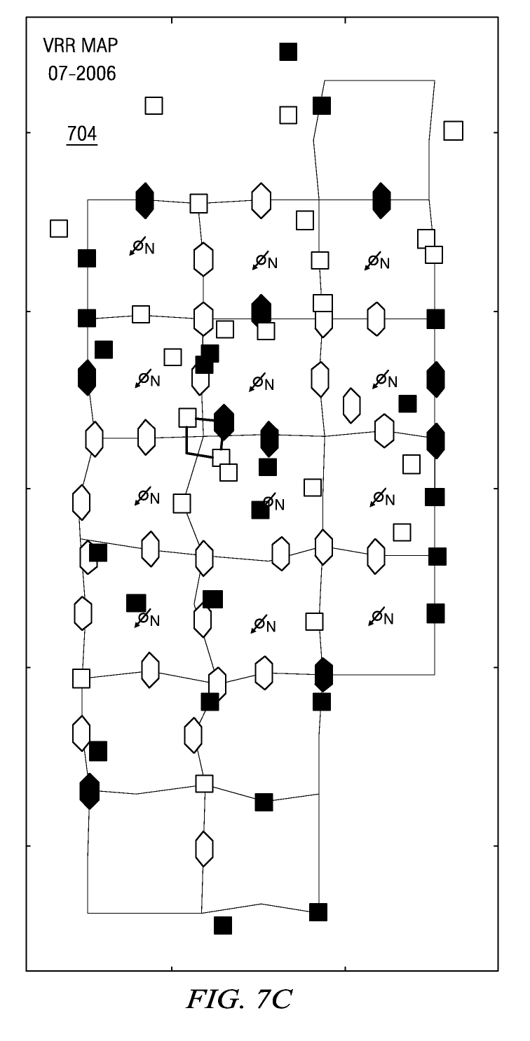

FIGS. 7-9 are illustrations depicting workflows for generating various map displays using waterflood performance monitoring system 600.

FIG. 7 is an illustration depicting a workflow for generating pattern base maps. More particularly, FIG. 7 illustrates VRR monthly pattern base maps 702 and 704, and Finder database 706, and schematically illustrates the extraction of selected data needed to generate base maps 702 and 704. Finder database 706 may be implemented as Finder database 604 in FIG. 6. As shown in FIG. 7, selected data related to VRR pattern 710, dual string wells 712 and single string wells 714 are accessed and extracted from finder database 706. As described, with reference to FIG. 6, this extracted data is processed by SQL statements and user defined functions 612 embedded in data extraction and processing mechanism 606 and displayed by data visualizing mechanism 608 as base maps 702 and 704.

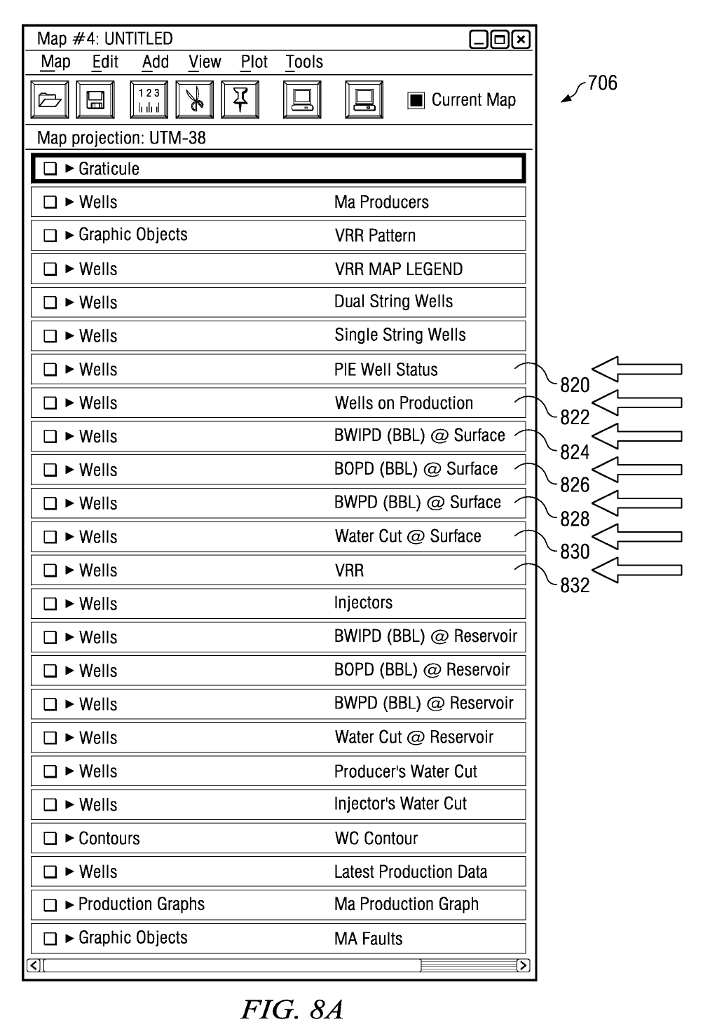

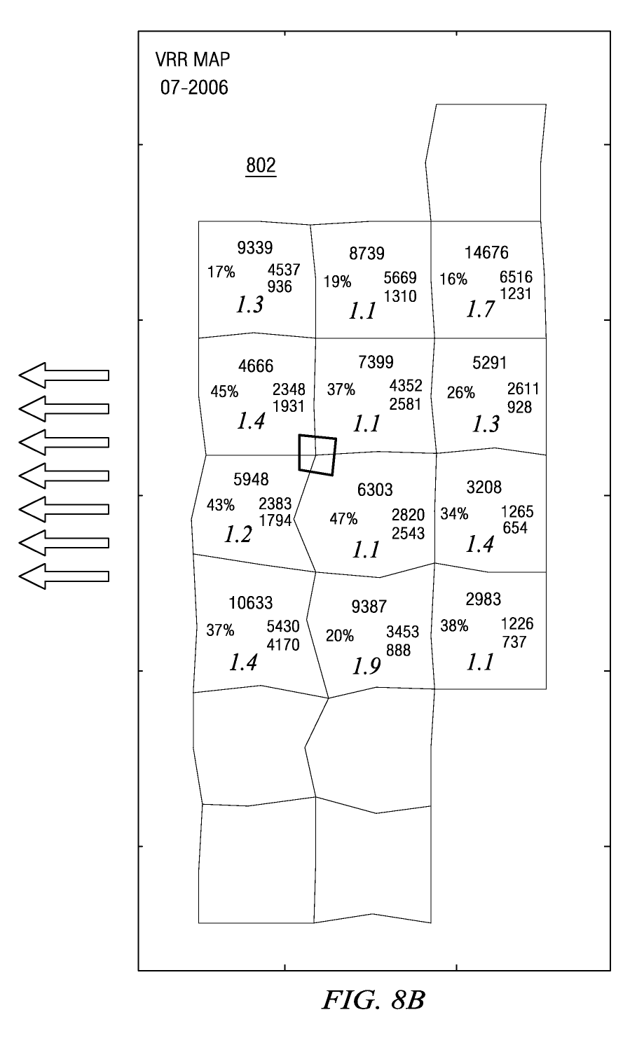

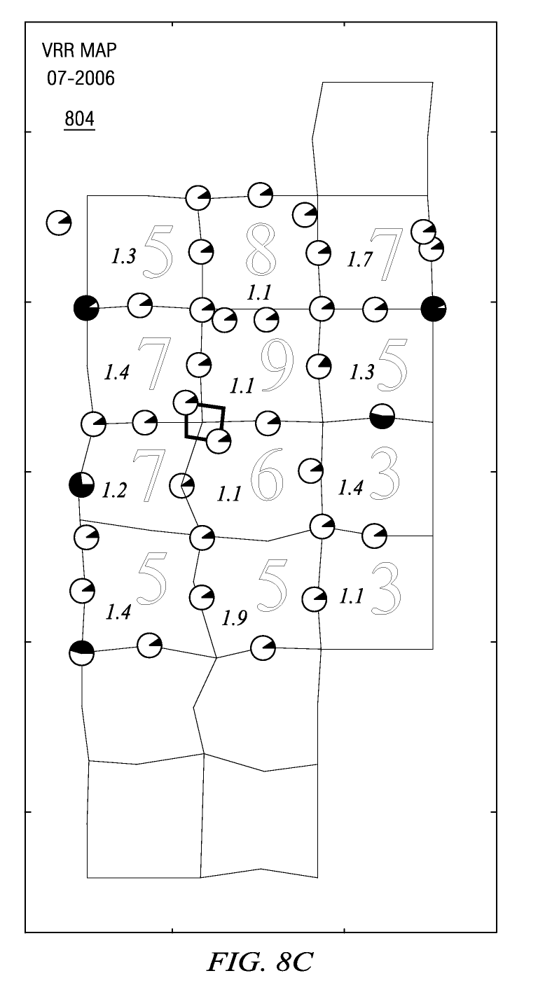

FIG. 8 is an illustration depicting a workflow for generating pattern VRR maps. As shown, the work flow for generating monthly VRR maps 802 and 804 include accessing and extracting data from Finder database 706 relating to PIE well status 820, wells on production 822, BWIPD (BBL) at the surface 824, BOPD (BBL) at the surface 826, BWPD (BBL) at the surface 828, water cut at surface 830 and VRR 832. This extracted data is processed and displayed as maps 802 and 804.

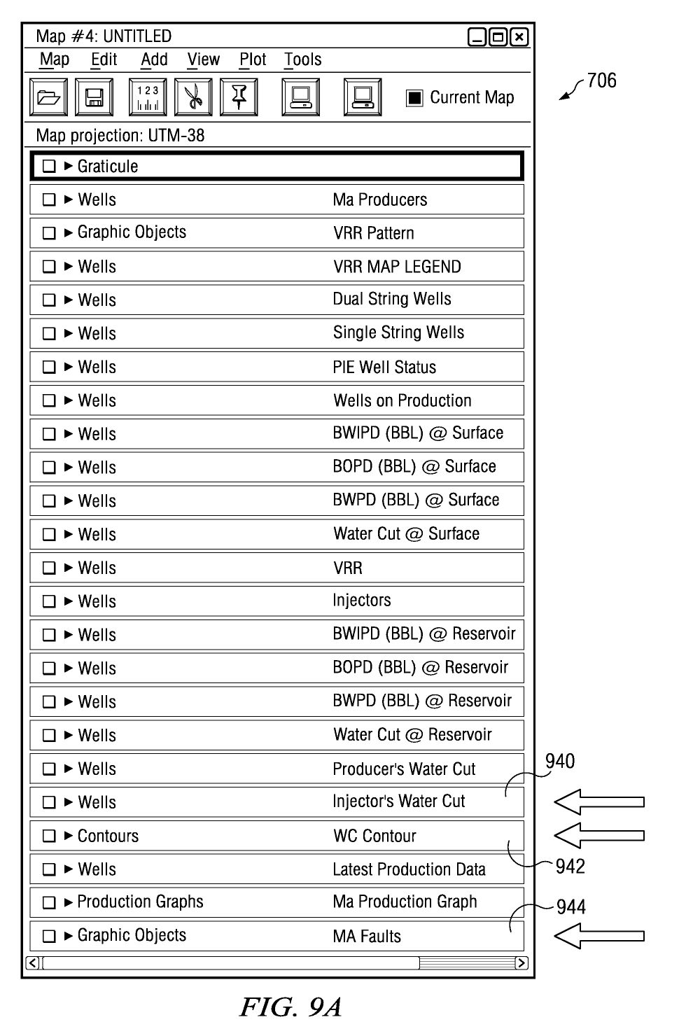

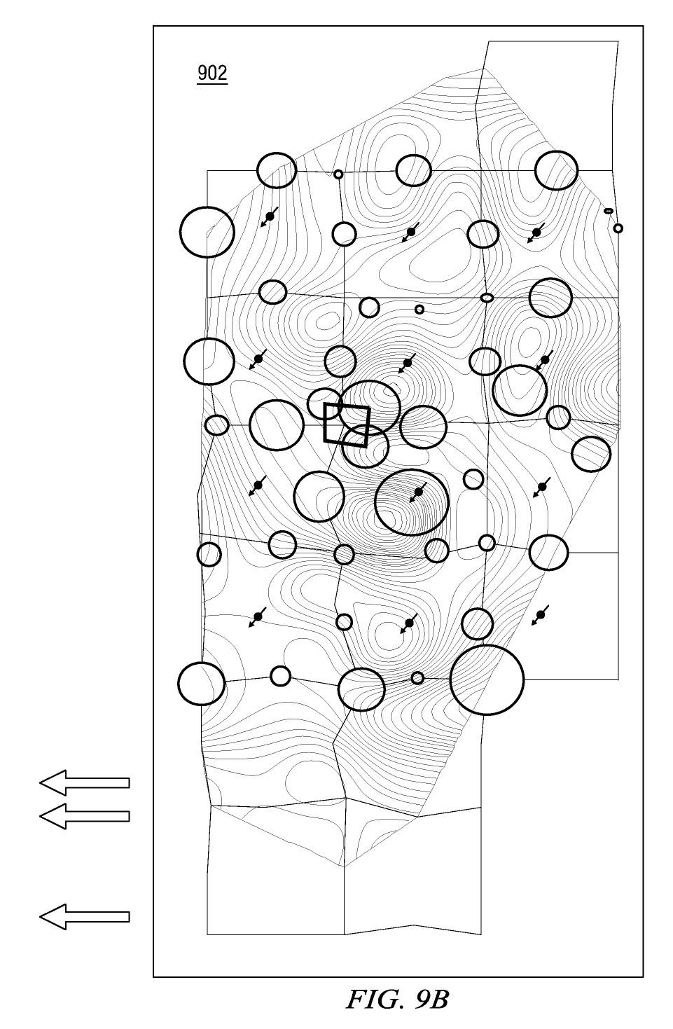

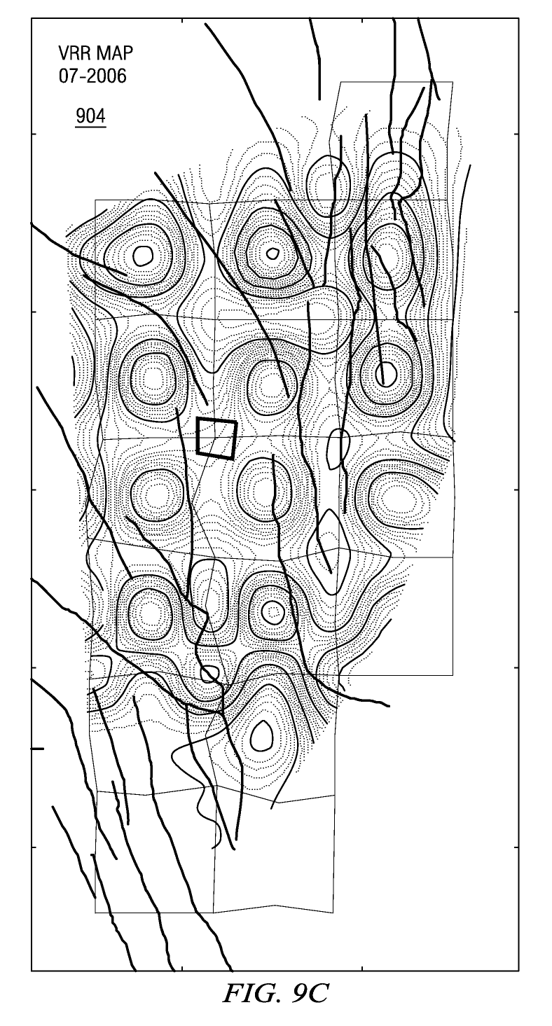

FIG. 9 is an illustration depicting a workflow for generating injector/producer water cut maps. As illustrated, the workflow for generating maps 902 and 904 include accessing and extracting data from Finder database 706 relating to injectors water cut 940, WC contour 942 and MA faults 944. This extracted data is processed and displayed as maps 902 and 904.

Maps 702, 704, 802, 804, 902, and 904 illustrated in FIGS. 7-9 are examples of dynamic information system-based maps that may be superimposed on a Finder database. Other dynamic maps providing different information may also be generated and superimposed on the database. This enables a single application, the “Finder SmartMap” application, to map selected parameters for viewing and evaluation by users in a manner that significantly exceeds traditional data viewing in forms, tables, and spreadsheet formats.

Mapping of parameters may be performed in various domains. The following summarizes five major domains in which mapping of parameters may be performed. It should be understood, however, that the following domains are intended to be exemplary only:

1ii. Pattern monthly Voidage Replaceme
iii. Pattern cumulative VRR
iv. Field monthly VRR
v. Field Cumulative VRR
vi. Pattern average daily oil and water cut at surface and reservoir condition
vii. Water cut contour map superimposed by fault structure

2. Daily Production Performance
i. Well latest water cut bubble diagram
ii. Well latest completion status (open/close)
iii. Well liquid rate bubble diagram
iv. Overproducing wells and under producing wells
v. (This layout displays the gap between set allowable and actual daily production rates from latest validated tests in Finder in the form of a bubble diagram. The diagram may be color coded, for example, in red and green (or other combinations), for over producing and under producing wells, respectively, and also, the size of the bubbles may be in proportion of the amount of gap between the allowable and actual rates.)
vi. Well head pressure vs. flow line pressure
vii. (This layout displays wells which are not performing under optimum well head pressure (WHP) as compared to their flow line pressure (FLP). Engineers can easily identify those wells where WHP approached FLP.)
viii. Dry and wet headers
ix. (This layout displays dry oil wells which are hooked up to wet header. Engineers can open another layout in the same map and check out the latest production rates for individual wells. The map can also roll up the total production rate for all the wells in this category and display it. This will assist engineers in calculating production gains by connecting those wells to dry header and increase the capacity for adding new wet wells.)

3. Monthly Production Performance
i. (In this process, production gain or loss is monitored to determine the causes behind any production performance anomalies.)
ii. Oil gain or loss
iii. (This layout calculates production gain or loss between two given months for an entire field and reservoir. It also produces a color coded bubble diagram for the wells that contributed to gain/loss. The comparison is on fluid rate and water cut on individual wells.)
iv. Productive days
v. (This layout produces pie charts depicting number of days during which wells have been open or closed.)

4. Well Surveillance Activities (Rig less)
i. Review latest well surveillance such as: Portable GOR test, SBHP, FBHP, PBU, PLT and TDT
ii. (Each data set may be characterized using color coded symbols based on age of corresponding activity which in turn can help engineers prioritize their asset action plans for rig less activities.)

5. Drilling and Workover Activities (Rig)
i. See latest rig workover summary for each well.
ii. (This layer can show rig on location with rig name and number of rig day activity. This data is live and changes day by day. )

As part of a Finder SmartMap standard feature for each of the layouts identified above, engineers are able to pick any well and drill down into corresponding form or report and study the detailed information.

In general, a workflow, such as the workflows illustrated in FIGS. 7-9, provides a seamless solution to evolve raw data into valuable information by integrating the Finder database with an interactive data processing algorithm and a dynamic graphical interface to visualize multi-disciplinary information. As a result, well review sessions are able to be conducted more effectively and with greater efficiency.

A feature about the new workflow is that the entire process of data gathering and processing may be reduced from days to minutes, leaving engineers with enough time to carry out their core business of interpretation and decision making, rather than struggling with data management challenges.

FIG. 10 is a flowchart of a method for monitoring waterflood performance. The method is generally designated by reference number 1000, and begins by collecting data regarding an oilfield (Step 1002). The data may be gathered from numerous sources including sensors, such as sensors S illustrated in FIGS. 1A-1D and FIGS. 4A-4B, and includes data relating to oil production and water injection.

The collected data is stored in a database (Step 1004), preferably a Finder database. The stored data may include data collected over an extended period of time. User input is then received (Step 1006). The user input may specify a selected waterflood performance parameter of interest, as well as a time period over which information is desired, for example, a week or a month. Based on the user input, data relating to the selected parameter is extracted from the database (Step 1010). The selected data that is extracted is data in the database that is needed to display the requested information to the user.

The extracted data is then processed (Step 1008). The processing is performed using SQL statements and user defined functions embedded within a data extraction and processing mechanism such as data extraction and processing mechanism 606 in FIG. 6. The processed data is then dynamically displayed (Step 1012). The displaying may be accomplished via a GIS-based data visualizing mechanism, such as data visualizing mechanism 608 in FIG. 6.

While specific configurations of systems for performing oilfield operations are depicted, it will be appreciated that various combinations of the described systems may be provided. For example, various combinations of selected modules may be connected using the connections previously described. One or more modeling systems may be combined across one or more oilfields to provide tailored configurations for modeling a given oilfield or portions thereof. Such combinations of modeling may be connected for interaction therebetween. Throughout the process, it may be desirable to consider other factors, such as economic viability, uncertainty, risk analysis and other factors. It is, therefore, possible to impose constraints on the process. Modules may be selected and/or models generated according to such factors. The process may be connected to other model, simulation and/or database operations to provide alternative inputs.

It will be understood from the foregoing description that various modifications and changes may be made in the preferred and alternative embodiments of the present invention without departing from its true spirit. For example, during a real-time drilling of a well it may be desirable to update the oilfield model dynamically to reflect new data, such as measured surface penetration depths and lithological information from the real-time well logging measurements. The oilfield model may be updated in real-time to predict key parameters (for example, pressure, reservoir fluid or geological composition, etc.) in front of the drilling bit. Observed differences between predictions provided by the original oilfield model concerning well penetration points for the formation layers may be incorporated into the predictive model to reduce the chance of model predictability inaccuracies in the next portion of the drilling process. In some cases, it may be desirable to provide faster model iteration updates to provide faster updates to the model and reduce the chance of encountering any expensive oilfield hazard.

This description is intended for purposes of illustration only and should not be construed in a limiting sense. The scope of this invention should be determined only by the language of the claims that follow. The term “comprising” within the claims is intended to mean “including at least” such that the recited listing of elements in a claim are an open group. “A,” “an” and other singular terms are intended to include the plural forms thereof unless specifically excluded. In addition, the term “set of” means one or more.

The flowcharts and block diagrams in the different depicted embodiments illustrate the architecture, functionality, and operation of some possible implementations of methods, apparatus, and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, implemented in a computer, for controlling a production/injection operation for an oilfield, the oilfield having a first wellsite comprising a producing well advanced into subterranean formations with geological structures and reservoirs therein, the producing well being for production of fluids from at least one reservoir in the reservoirs, wherein the oilfield further has a second wellsite comprising an injection well advanced into the subterranean formations with the geological structures and the reservoirs, the injection well being therein for injection of fluids into the at least one reservoir, wherein the method comprises:
collecting collected data from a plurality of data sources with respect to the production/injection operation, wherein the collected data includes oil production data from the producing well and fluid injection data from the injection well;
storing the collected data in a database;
extracting extracted data from the database, wherein the extracted data relates to a selected performance parameter to be monitored;
processing the extracted data to form processed data; and
dynamically displaying a graphical representation of the processed data to enable monitoring of the selected performance parameter.

2. The method of claim 1, wherein the steps of extracting the extracted data, processing the extracted data and dynamically displaying the graphical representation of the processed data are performed using a single application.

3. The method of claim 2, wherein the single application includes embedded structured query language statements and user defined functions for processing the extracted data.

4. The method of claim 2, wherein dynamically displaying the graphical representation of the processed data to enable monitoring of the selected performance parameter comprises projecting the processed data onto a geographic information system-based map.

5. The method of claim 1, and further comprising:
receiving user input regarding the selected performance parameter to be monitored.

6. The method of claim 5, wherein the user input further comprises a selected time period, and wherein dynamically displaying the graphical representation of the processed data to enable monitoring of the selected performance parameter, comprises:
dynamically displaying the graphical representation of the processed data for the selected time period.

7. The method of claim 6, wherein the selected time period comprises one week.

8. The method of claim 6 wherein the selected time period comprises one month.

9. The method of claim 1 wherein the selected performance parameter comprises a waterflood performance parameter.

10. The method of claim 1 wherein the selected performance parameter comprises a change of an injection rate of the injection well.

11. The method of claim 1 wherein the selected performance parameter comprises a change of production rate of the producing well.

12. The method of claim 1, wherein the selected performance parameter comprises one of a parameter relating to waterflood performance, daily production performance, monthly production performance, rig less well surveillance activities, or drilling and workover activities.

13. The method of claim 1 further comprising changing a parameter of the production/injection operation in the oilfield based on information obtained from the graphical representation.

14. A system for controlling a production/injection operation for an oilfield, the oilfield having a first wellsite comprising a producing well advanced into subterranean formations with geological structures and reservoirs therein, the producing well being for production of fluids from at least one reservoir in the reservoirs, wherein the oilfield further has a second wellsite comprising an injection well advanced into the subterranean formations with the geological structures and the reservoirs, the injection well being therein for injection of fluids into the at least one reservoir, wherein the system comprises:
a plurality of data collecting mechanisms for collecting collected data with respect to the production/injection operation, wherein the collected data includes oil production data from the producing well and fluid injection data from the injection well;
a database, stored on a computer readable medium, for storing the collected data;
a data extraction and processing mechanism for extracting extracted data from the database, the extracted data relating to a selected performance parameter to be monitored, the data extraction and processing mechanism also for processing the extracted data to form processed data; and
a data visualizing mechanism for dynamically displaying a graphical representation of the processed data to enable monitoring of the selected performance parameter.

15. The system of claim 14, wherein the data extraction and processing mechanism and the data visualizing mechanism comprises a single application stored on the computer readable medium.

16. The system of claim 15, wherein the single application includes embedded structured query language statements and user defined functions for processing the extracted data.

17. The system of claim 15, wherein the data visualizing mechanism comprises a mechanism for projecting the processed data onto a geographic information system-based map.

18. The system of claim 14, and further comprising:
a user interface for receiving user input regarding the selected performance parameter to be monitored.

19. The system of claim 14 wherein the selected performance parameter comprises a waterflood performance parameter.

20. The system of claim 14, wherein the selected performance parameter comprises one of a parameter relating to waterflood performance, daily production performance, monthly production performance, rig less well surveillance activities, or drilling and workover activities.

21. The system of claim 14 further comprising a mechanism for changing a parameter of the production/injection operation in the oilfield based on information obtained from the graphical representation.

22. The system of claim 21 wherein the mechanism for changing the parameter of the production/injection operation comprises a mechanism for changing an injection rate of the injection well.

23. The system of claim 21 wherein the mechanism for changing the parameter of the production/injection operation comprises a mechanism for changing production rate of the producing well.

24. A computer program product comprising a computer usable medium having computer usable program code for controlling a production/injection operation for an oilfield, the oilfield having a first wellsite comprising a producing well advanced into subterranean formations with geological structures and reservoirs therein, the producing well being for production of fluids from at least one reservoir in the reservoirs, wherein the oilfield further has a second wellsite comprising an injection well advanced into the subterranean formations with the geological structures and the reservoirs, the injection well being therein for injection of fluids into the at least one reservoir, wherein the computer program product comprises:
computer usable program code for collecting collected data from a plurality of data sources with respect to the production/injection operation, wherein the collected data includes oil production data from the producing well and fluid injection data from the injection well;
computer usable program code for storing the collected data in a database;
computer usable program code for extracting extracted data from the database, the extracted data relating to a selected performance parameter to be monitored;
computer usable program code for processing the extracted data to form processed data; and
computer usable program code for dynamically displaying a graphical representation of the processed data to enable monitoring of the selected performance parameter.

25. The computer program product of claim 24, wherein the computer usable program code for extracting, the computer usable program code for processing, and the computer usable program code for dynamically displaying comprises a single application.

26. The computer program product of claim 25, wherein the single application includes embedded structured query language statements and user defined functions for processing the extracted data.

27. The computer program product of claim 25, wherein the computer usable program code for dynamically displaying the graphical representation of the processed data to enable monitoring of the selected performance parameter comprises: computer usable program code for projecting the processed data onto a geographic information system-based map.

28. The computer program product of claim 24, and further comprising:
computer usable program code for receiving user input regarding the selected performance parameter to be monitored.

29. The computer program product of claim 28, wherein the user input further comprises a selected time period, and wherein the computer usable program code for dynamically displaying the graphical representation of the processed data to enable monitoring of the selected performance parameter further comprises:
computer usable program code for dynamically displaying the graphical representation of the processed data for the selected time period.

30. The computer program product of claim 24 wherein the selected performance parameter comprises a waterflood performance parameter.

31. The computer program product of claim 24 wherein the selected performance parameter comprises a change of an injection rate of the injection well.

32. The computer program product of claim 24 wherein the selected performance parameter comprises a change of production rate of the producing well.

33. The computer program product of claim 24, wherein the selected performance parameter comprises one of a parameter relating to waterflood performance, daily production performance, monthly production performance, rig less well surveillance activities, or drilling and workover activities.

34. The computer program product of claim 24 further comprising computer usable program code for changing a parameter of the production/injection operation in the oilfield based on information obtained from the graphical representation.
